(19) United States
(12) Patent Application Publication
(10) Pub. No.: US 2005/0102893 A1
(43) Pub. Date: May 19, 2005

(54) Lawn-edging strip

(76) Inventor: Anthony Richard O'Connor, Croydon (GB)

Correspondence Address: HUNTLEY & ASSOCIATES, 1105 NORTH MARKET STREET, P.O. BOX 948, WILMINGTON, DE, 19899-0948, US

(21) Appl. No.: 10/504,824

(22) PCT Filed: Sep. 25, 2002
(86) PCT No.: PCT/GB02/04340

(30) Foreign Application Priority Data
Feb. 14, 2002 (GB) 0203514.5

(51) Int. Cl. A01G 1/00

(52) U.S. Cl. 47/33

(57) ABSTRACT

A plastic lawn-edging strip (1) for separating different areas of lawns and gardens comprises an elongate strip of plastic material formed from a) a first elongate portion (2), comprising bottom edge (5), inner and outer faces (6), adapted to allow forced insertion thereof into the ground between a lawn and a garden and to form a wall to the lawn edge; and, connected to the first portion, b) a second elongate portion (3), comprising top edge (7), inner and outer faces (8, 9), and a plurality of apertures (10) adapted such that in use said apertures receive grass and grass roots that anchor said second elongate portion to the lawn.

This invention is concerned with a moulded plastic lawn-edging strip for separating different areas of lawns and gardens. More particularly, the present invention is concerned with lawn edging strip that is manufactured in the form of a ribbon, that enables it to be rolled up for ease of handling, transport and storage prior to use.

Lawn edging strips have been used for many years to create borders between lawns and gardens. Whilst providing an attractive, well defined edge between the lawn and the garden e.g. flower bed, the edging strip is also used to prevent grass roots from extending into the garden from the lawn.

Lawn-edging strips have been made of brick, concrete block, wood, metal, and plastic. Traditionally, edging strips made of brick, concrete block, wood and metal required the excavation of a trench along the desired layout of the edging. The edging strip was then placed in the trench and the trench backfilled along the edging. Metal edging strip also required the use of separate stakes to hold the metal in place during installation and, especially, over long periods of time as weathering of the soil around the strip tended to dislodge the strip and stakes from a firm position. The strip and/or stakes require replacing or re-firming from time to time, e.g. at least annually, to keep the strip in position

To overcome the problem of rusting in metal edging strips, plastic edging strips were introduced. Such plastic edging strips were manufactured in ribbons and were sufficiently flexible that they could be rolled-up for ease of handling and storage prior to use. However, like the metal edging strips, these too required the excavation of a trench and the use of stakes to hold the strip in place during installation and over periods of extended use.

U.S. Pat. No. 5,456,045 discloses a lawn-edging strip that does not require the excavation of a trench prior to installation. The strip has a top edge configured for withstanding hammering, a bottom edge configured for penetrating into the ground, and ends constructed for interlocking with adjacent strips. The strips are presented in short lengths that may be connected together. The strips are likely to become dislodged from their position over a long period of time due to weathering of the soil.

U.S. Pat. No. B16,234,783 discloses a moulded plastic strip with integrally moulded plastic spikes that can be severed on site for use in installation and also serve during storage and handling to stiffen the rear edge of the flexible plastic edging strip. The horizontal footing of the strip is provided with apertures for receiving the spikes. The strips are likely to become dislodged from their position over a long period of time due to weathering of the soil.

DE-A-19528516 discloses an ornamental slab or disc, made of a flat sheet of aluminium, used as a stepping-stone in grass. The slab settles into the lawn and has a number of apertures so that grass can grow through and anchor it in place.

U.S. Pat. No. 3,916,563 discloses a lawn edge trim guard made from a plurality of connected rigid elements, each element comprising an imperforate plate that extends vertically into the soil to a depth beyond which grass roots and roots of garden flowers are unable to grow, and a horizontal grid of shorter plates, the upper edges of which are adapted to be substantially level with the surface of the soil and which permit the grass to grow through the interstices of the grid. Each element is provided with a flexible plate extension that permits adjacent elements to be connected and adjusted to follow the contours of the lawn.

DE-A-3217953 discloses a lawn edging strip made from metal sheet or plastic sheeting and has a vertical leg and a horizontal leg. The two end regions of the legs have v-shaped points which are formed by zig-zag cut-outs. The front half of the points in the horizontal part are bent vertically downwards and are anchored in the soil, as is the vertical leg. The strip is of a flanged construction so that it is not easily bent

It is the object of the present invention to provide a plastic lawn-edging strip that does not essentially require the excavation of a trench prior to installation and that will not become dislodged from position over a long period of time. Preferably, such edging should also be manufactured in a form that enables it to be rolled-up for ease of handling, transport and storage prior to use.

In accordance with the present invention there is provided a plastic lawn-edging strip comprising a ribbon of plastic material formed from a) a first elongate portion, comprising bottom edge, inner and outer faces, adapted such that in use the first elongate portion is forced into the ground between a lawn and a garden and forms a wall to the lawn edge, wherein said inner face abuts the lawn edge, and wherein said wall is impenetrable to grass roots; and, connected to the first portion, b) a second elongate portion, comprising top edge, inner and outer faces and a plurality of apertures, adapted such that in use the inner face of said second elongate portion abuts the top surface of the lawn and wherein said apertures receive grass and grass roots to thereby anchor said second elongate portion to the lawn. In one embodiment of the invention, said first and second elongate portions are rigidly connected with the inner faces of both portions being substantially perpendicular to each other. In another embodiment, the first and second portions are connected by a hinge running the length of said strip between said first and second elongate portions.

In accordance with another aspect of the present invention, there is provided a method of securing a lawn edging strip to a lawn, wherein the lawn edging strip comprises a ribbon of plastic material formed from a) a first elongate portion, comprising bottom edge, inner and outer faces, adapted such that in use the first elongate portion is forced into the ground between a lawn and a garden and forms a wall to the lawn edge, wherein said inner face abuts the lawn edge, and wherein said wall is impenetrable to grass roots; and, connected to the first portion, b) a second elongate portion, comprising top edge, inner and outer faces and a plurality of apertures, adapted such that in use the inner face of-said second elongate portion abuts the top surface of the lawn and wherein said apertures receive grass and grass roots to thereby anchor said second elongate portion to the lawn; wherein the method comprises:
i) using force and with said inner face of said first elongate portion abutting the edge of said lawn, inserting said bottom edge and a part of said first elongate portion into the ground between said lawn and a garden until said second elongate portion lies on top of the lawn with said inner face of said second elongate portion abutting the surface of the lawn; and
ii) growing grass through the apertures thereby to anchor said second elongate portion to the lawn.

When the first and second elongate portions are connected by a hinge running the length of the strip, the method comprises: the method comprises:
i) using force and wit said inner face of said first elongate portion abutting the edge of said lawn, inserting said bottom edge and a part of said first elongate portion into the ground between said lawn and a garden until said hinge is at about the same height above the garden as the surface of the lawn;
ii) bending said lawn edging strip along said hinge;
iii) laying said second elongate portion on top of the lawn and applying sufficient force on at least a part of said outer surface of said second elongate portion until said inner face of said second elongate portion and the surface of the lawn abut; and
growing grass through the apertures thereby to anchor said second elongate portion to the lawn. The lawn edging-strip may be bent along the hinge either before or after the first portion has been inserted into the ground.

Once the lawn-edging strip has been initially fitted to the lawn, after a short period of time the grass in the lawn begins to grow through the apertures and, eventually, over the parts of the second elongate portion between the apertures, thereby creating a web of grass and roots that anchor the second elongate portion to the lawn and, in turn, anchor the strip in place. This is highly advantageous over the prior art lawn-edging strips that, having no long term anchoring means, tend become loose over time e.g. due to soil weathering.

The lawn-edging strip of the present invention may be supplied in short lengths, e.g. the strip may be supplied to retailers in short cut lengths, preferably in lengths from 0.5 to 2 m, more preferably in lengths of about 1 m. Alternatively, the plastic lawn-edging strip may be supplied in the form of a rolled-up coil of the ribbon e.g. the strip may be supplied to retailers in coiled lengths from 5 to 200 m (a 200 m coil, for example, enables a retailer to sell measured shorter lengths of the strip cut from the coil as specified by the customer), preferably in coiled lengths of from 5 to 30 m, more preferably in coiled lengths of 15 to 20 m. This latter format is particularly suitable for handling, transporting and storing the strip prior to use.

The first elongate portion preferably comprises at least 50%, more preferably at least 65%, of the width of the lawn-edging strip. The first elongate portion comprises bottom edge, inner and outer faces and is adapted to allow forced insertion thereof into the ground between a lawn and a garden and to form a wall to the lawn edge. In this regard, the first portion is preferably provided with a saw-toothed edge that preferably comprises no more than 50%, more preferably less than 40%, even more preferably less than 33%, of the width of the first portion. The first portion may comprise a plurality of reinforcing ribs oriented substantially perpendicular to the length of the first portion, which ribs may be used alone or in addition to said saw-toothed edge.

The second elongate portion of the strip preferably comprises no more than 50%, preferably less than 35%, of the width of the lawn-edging strip. The second elongate portion comprises top edge, inner and outer faces, and a plurality of apertures adapted such that in use said apertures receive grass and grass roots to anchor said second elongate portion to the lawn. The apertures for receiving the grass and grass roots required to anchor the portion to the ground preferably comprise at least 50%, more preferably at least 65%, even more preferably at least 75%, of the surface area of the second elongate portion. The second portion is preferably provided with a saw-toothed edge that preferably comprises more than 50%, more preferably more than 75%, even more preferably more than 90%, e.g. 100%, of the width of the first portion. The saw-toothed edge is preferred as this assists easy laying of the strip on corners of the lawn, though other profiles can be envisaged to the same purpose.

The second portion may also be provided with one or more apertures for receiving stakes. The use of a stake may assist retaining the second elongate portion in position on the lawn before the grass has had opportunity to grow through the apertures. Alternatively, the second elongate portion may be provided with integrally moulded stake-like projections that can be pushed into the lawn when the second elongate portion is placed in position on the lawn. In either event, the stakes are not considered to provide a long-term solution to the problem of anchoring the strip in place.

When said first and second elongate portions are rigidly connected with the inner faces of both portions being substantially perpendicular to each other, the top edge of the second elongate portion is profiled such that the strip may be readily coiled. Preferably, the top edge of the second elongate portion is tooth-edged, as described above, though other profiles can be envisaged to the same purpose.

Preferably the lawn-edging strip is formed from a single plastic moulding, wherein the first and second portions are all formed integrally. Alternatively, the first and second portions may be formed separately and then joined together.

Whilst the lawn-edging strip of the present invention may be employed on new lawns, it is preferably employed on established or mature lawns, when the second portion is laid over grass already growing on the lawn

In one embodiment of the present invention, the lawn-edging strip may carry an advertisement on at least a part of the outer face of the first elongate portion. Preferably, the advertisement is on a part of the outer face that may be visible when the strip is secured in place on the lawn.

In another embodiment, the lawn-edging strip may be provided with means for attaching an advertisement board or pyramid to said strip. The means may be such that the advertisement board or pyramid is permanently fixed to the strip or temporarily fixed to the strip e.g. by a clip or slot mechanism. This embodiment is particularly useful when the strip is used at a golf course, e.g. for separating a tee from the fairway, or the fairway from the rough.

The invention will now be further illustrated by way of example and with reference to the accompanying drawings:

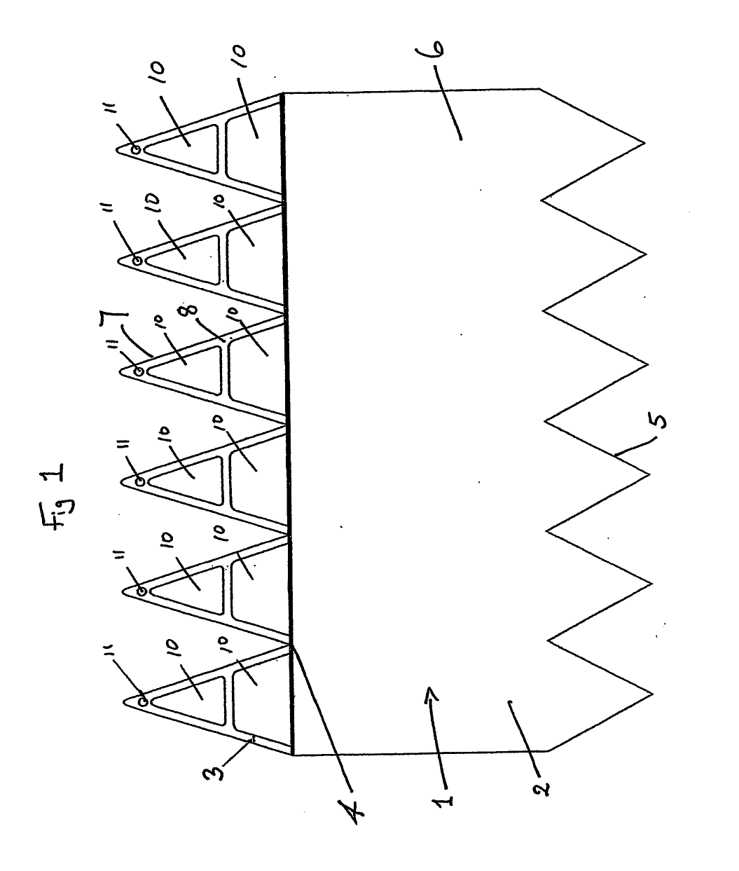

FIG. 1 Is a plan view of a short section of lawn edging strip in accordance with the present invention.

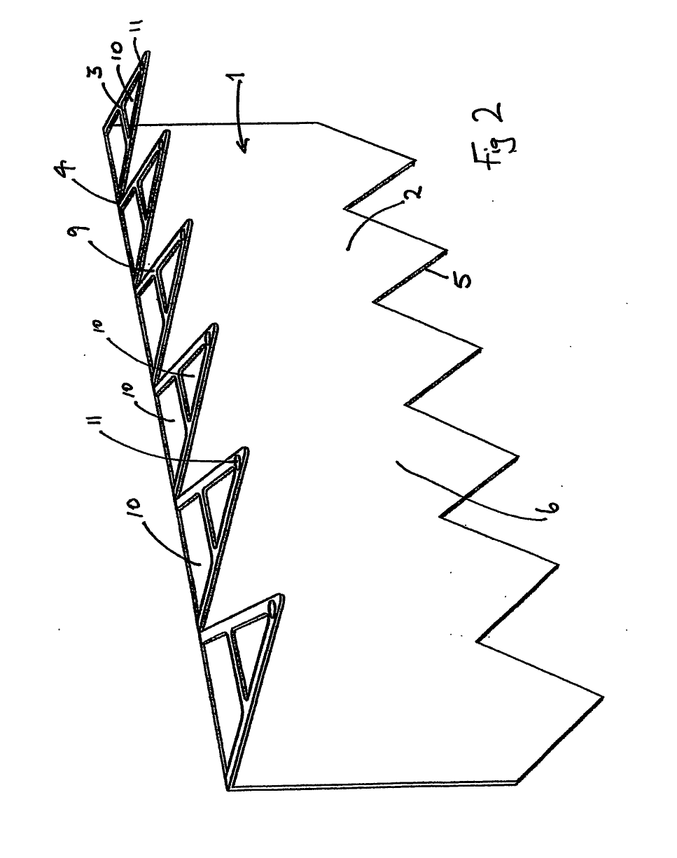

FIG. 2 Is a perspective view of a short section of a preferred lawn edging strip in accordance with the present invention, wherein the first and second elongate portions are rigidly connected to each other.

With reference to FIG. 1 and FIG. 2, in which FIG. 2 is a particularly preferred embodiment, a lawn edging strip 1 comprises a first elongate portion 2, a second elongate portion 3, and a hinge 4 extending along the length of the strip. The strip 1 is manufactured from a 3 mm thick injection moulded polyethylene, and when made in lengths of 30 metres may be rolled-up into a coil having a diameter of 50-100 cm.

The first elongate portion 2 comprises a bottom edge 5 and inner face 6. The outer face of the first elongate portion is not shown. The first portion 2 is adapted to allow forced insertion thereof into the ground between a lawn and a garden by the provision of a saw-toothed edge, wherein each tooth is approximately 40 mm wide and 40 mm deep (max). A section of the portion 2 of about 10 cm wide extends from the saw-toothed edge to the hinge 4.

The second elongate portion 3 comprises a top edge 7, inner face 8 and outer face 9. The portion is provided with a saw-toothed edge wherein each tooth is approximately 40 mm wide and 60 mm deep (max). A plurality of large apertures 10 formed in the second elongate portion will in use receive grass and grass roots that, in time, will anchor the portion to the lawn. The apertures are illustrated to occupy at least 75% of the surface area of the second portion. In this particular embodiment, the second elongate portion is also provided with a plurality of smaller apertures 11 through which stakes may be passed to hold the portion in place before the grass has had opportunity to grow over the portion.

A narrowing of the strip at the junction of the first and second portions forms the hinge 4. The hinge permits the second portion to be bent over so that it may lie substantially perpendicular to the first portion.

The lawn-edging strip 1 is secured to the lawn by inserting the first portion 2 down into the ground between the lawn and garden until the hinge 4 is about level with the top surface of the lawn. The second portion 3, being substantially perpendicular to the first portion, then lies flat over the top surface of the lawn, with the inner face 8 in contact with the lawn. As grass grows through the apertures it anchors the second portion to the lawn and consequently the lawn-edging strip in position.

Depending upon the conditions of the soil and lawn before the grass has had opportunity to grow through the apertures 10, it may be necessary to stake the second portion to the lawn by inserting the stakes through the stake apertures 11. Over time, however, these stakes will become loose due to weathering of the soil. The lawn-edging strip, however, does not require repositioning or the stakes replaced as the grass replaces the function of the stakes to anchor the second portion in position.

1. A plastic lawn-edging strip comprising a ribbon of plastic material formed from a) a first elongate portion, comprising bottom edge, inner and outer faces, adapted such that in use the first elongate portion is forced into the ground between a lawn and a garden and forms a wall to the lawn edge, wherein said inner face abuts the lawn edge, and wherein said wall is impenetrable to grass roots; and, connected to the first portion, b) a second elongate portion, comprising top edge, inner and outer faces and a plurality of apertures, adapted such that in use the inner face of said second elongate portion abuts the top surface of the lawn and wherein said apertures receive grass and grass roots to thereby anchor said second elongate portion to the lawn.

2. A plastic lawn-edging strip as claimed in claim 1, comprising c) a hinge running the length of said strip between said first and second elongate portions and joining said first and second elongate portions together.

3. A plastic lawn-edging strip as claimed in claim 1 or claim 2, wherein the plastic lawn-edging strip is in a form that has been rolled-up into a coil.

4. A plastic lawn-edging strip as claimed in any one of claims 1 to 3, wherein the first elongate portion comprises at least 50% of the width of the lawn-edging strip.

5. A plastic lawn-edging strip as claimed in claim 4, wherein the first elongate portion comprises at least 65% of the width of the lawn-edging strip.

6. A plastic lawn edging strip as claimed in any one of the preceding claims, wherein the first portion is provided with a saw-toothed edge.

7. A plastic lawn-edging strip as claimed in claim 6, wherein less than 33% of the width of the first portion is provided with a saw-toothed edge.

8. A plastic lawn-edging strip as claimed in any one of the preceding claims, wherein the first portion comprise a plurality of reinforcing ribs oriented substantially perpendicular to the length of the first portion.

9. A plastic lawn-edging strip as claimed in any one of the preceding claims, wherein the second elongate portion of the strip comprises no more than 50%, preferably less than 35%, of the width ofthe lawn-edging strip.

10. A plastic lawn-edging strip as claimed in any one of the preceding claims, wherein the apertures for receiving the grass and grass roots required to anchor the portion to the ground preferably comprise at least 50%, more preferably at least 65%, even more preferably at least 75%, of the surface area of the second elongate portion.

11. A plastic lawnedging strip as claimed in claimed 10, wherein the apertures for receiving the grass and grass roots required to anchor the portion to the ground preferably comprise at least 75% of the surfiae area of the second elongate portion.

12. A plastic lawn-edging strip as claimed in any one of the preceding claims, wherein the second portion is provided with a saw-toothed edge.

13. A plastic lawn-edging strip as claimed in claim 12, wherein the saw-toothed edge comprises 100% of the width of the second portion.

14. A plastic lawn-edging strip as claimed in any one of the preceding claims, wherein the second portion is provided with one or more apertures for receiving stakes.

15. A plastic lawn edging strip as claimed in any one of the preceding claims, wherein the second elongate portion is provided with integrally moulded stake-like projections that can be pushed into the lawn when the second elongate portion is placed in position on the lawn.

16. A lawn edging-strip as claimed in any one of the preceding claims, wherein the lawn-edging strip is formed from a single plastic moulding, wherein the first and second portions are formed integrally.

17. A lawn-edging strip as claimed in claim 2, wherein the first and second portions are separately formed from moulded plastic and then joined together at the hinge.

18. A method of securing a lawn edging strip to a lawn, wherein the lawn edging strip comprises a ribbon of plastic material formed form a) a first elongate portion, comprising bottom edge, inner and outer faces, adapted such that in use the first elongate portion is forced into the ground between a lawn and a garden and forms a wall to the lawn edge, wherein said inner face abuts the lawn edge, and wherein said wall is impenetrable to grass roots; and, connected to the first portion, b) a second elongate portion, comprising top edge, inner and outer faces and a plurality of apertures, adapted such that in use the inner face of said second elongate portion abuts the top surface of the lawn and wherein said apertures receive grass and grass roots and anchor said second elongate portion to the lawn; wherein the method comprises:
i) using force and with said inner face of said first elongate portion abutting the edge of said lawn, inserting said bottom edge and a part of said first elongate portion into the ground between said lawn and a garden until said second elongate portion lies on top of the lawn with said inner face of said second elongate portion abutting the surface of the lawn; and
ii) growing grass through the apertures to thereby anchor said second elongate portion to the lawn.

19. A method of securing a lawn edging strip as defined in claim 2 to a lawn, wherein the method comprises:
i) using force and with said inner face of said first elongate portion abutting the edge of said lawn, inserting said bottom edge and a part of said first elongate portion into the ground between said lawn and a garden until said hinge is at about the same height above the garden as the surface of the lawn;
ii) bending said lawn edging strip along said hinge;
iii) laying said second elongate portion on top of the lawn and applying sufficient force on at least a part of said outer surface of said second elongate portion until said inner face of said second elongate portion and the surface of the lawn abut; and
iv) growing grass through the apertures thereby to thereby anchor said second elongate portion to the lawn.
